(19) United States
(12) Patent Application Publication
(10) Pub. No.: US 2007/0088605 A1
(43) Pub. Date: Apr. 19, 2007

(54) System and method for achieving linear advertisement impression delivery under uneven, volatile traffic conditions

(75) Inventors: Sanjiv Ghate, Sunnyvale, CA (US); Harry Fung, Milpitas, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/253,907

(22) Filed: Oct. 19, 2005

(51) Int. Cl. G06Q 30/00

(52) U.S. Cl. 705/14

(57) ABSTRACT

A tolerance band is determined for an online advertisement campaign. The tolerance band defines upper and lower bounds on acceptable deviation from a cumulative linear advertisement delivery goal for the length of the campaign and may be employed to manage delivery of advertisement impressions during the campaign. The upper and lower bounds of tolerance band may flatten with time: acceptable deviation is generally higher at the beginning of the campaign and is lower as the campaign approaches its end date. The tolerance band may be employed to modify a periodically-determined delivery quota for an advertisement line based on the current performance of the advertisement line in relation to its tolerance band. An advertisement line that has fallen below the lower bound may get higher delivery priority relative to other advertisement lines so that it may be given more delivery opportunities. An advertisement line that is delivering above the upper bound may have its quota reduced, possibly to zero, and get lower delivery priority.

### FIELD OF THE INVENTION

The present invention relates generally to providing advertising content over a network, and more particularly, but not exclusively, to managing distribution of advertisements by way of a tolerance band that defines acceptable deviation from a cumulative advertisement delivery goal.

### BACKGROUND

Online advertising is often an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. The advertisement can be selected dynamically each time the page is requested for display by way of a browser application.

One common variety of online advertisement is the banner advertisement, which generally features an image (animated or static) and/or text displayed at a predetermined position in a page. A banner advertisement usually takes the form of a horizontal rectangle at the top of the page, but it can also be arranged in a variety of other shapes at any other location in the page. Typically, if a user, interacting by way of a browser application, clicks on the location, image, and/or text of the banner advertisement, the user is taken to a new page that may provide detailed information regarding the products or services associated with the banner advertisement.

Banner advertisements, as well as other kinds of advertisements, are often provided to network users by advertisement service providers (“publishers”) on a guaranteed number of impressions basis. An “impression” may be defined as a single advertisement presented to one user at one time. An advertiser typically engages a publisher to deliver a guaranteed specified total number of impressions to a targeted audience of network users and/or on a particular page or site over a predetermined period of time. This specified period may be referred to as an “advertisement campaign.” The set of advertisement impressions to be delivered in a campaign to a specified user audience profile may be referred to as an “advertisement line,” and the specified total number of impressions to be delivered is the campaign “goal.”

The actual distribution of delivered impressions during the length of a campaign depends on a number of factors, including the available opportunities for providing an advertisement and the selection of an advertisement line from among various lines to fulfill an advertisement request. Advertisers generally prefer publishers to control the delivery of impressions in a guaranteed advertisement campaign so that approximately the same number of impressions is delivered daily throughout a campaign. In practice, however, consistent advertisement delivery of this sort has been difficult to achieve, and the number of impressions actually delivered during various points in a campaign tends to vary substantially. One reason for this is the inherent unevenness and unpredictability of network traffic, which is a significant factor in influencing advertisement delivery opportunities. Traffic is different at different hours of the day and may be different for different days of the week; moreover, for some sites, traffic varies seasonally, and may be significantly higher than the normal traffic due to one-off events—predictable as well as unpredictable.

The difficulties experienced by advertisement publishers in managing advertisement delivery in a campaign contribute to problems of under-delivery and over-delivery of advertisement lines. When lines are under-delivered the total delivery goal is not met, resulting in lost or deferred revenue for the publisher. Over-delivery creates wasted inventory for the publisher.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following detailed description of the invention, which is to be read in association with the accompanying drawings, wherein:

FIG. 1 illustrates a graph of a cumulative linear advertisement delivery goal for an advertisement campaign;

FIG. 2 is a diagram illustrating one embodiment of an environment within which the invention may operate;

FIG. 3 is a logical flow diagram generally showing one embodiment of a process for managing delivery of advertisements in an advertisement campaign using delivery quotas;

FIG. 4 is a logical flow diagram generally showing one embodiment of a process for determining upper and lower bounds of a tolerance band for an advertisement line;

FIG. 5 illustrates a graph of a tolerance band for delivery of an advertisement line in an advertisement campaign;

FIG. 6 is a logical flow diagram generally showing one embodiment of a process for employing a tolerance band to derive delivery quotas of an advertisement campaign for the next delivery interval;

FIG. 7 is a logical flow diagram for an advertisement service provider employing tolerance bands to prioritize delivery of more than one advertisement lines;

FIG. 8 illustrates a graph of a tolerance band in which a narrower tolerance band is employed for a subperiod corresponding to the close of a sales quarter;

FIG. 9 is a logical flow diagram generally showing one embodiment of a process for establishing multiple intra-campaign tolerance bands for an advertisement line that is booked out-of-band; and

FIG. 10 illustrates a graph of delivery for an out-of-band advertisement line in which multiple intra-campaign tolerance bands are employed, in accordance with the invention.

### DETAILED DESCRIPTION OF THE DRAWINGS

The present invention will now be described more fully hereinafter with reference to the accompanying drawings, which form a part hereof, and which show, by way of illustration, specific exemplary embodiments by which the invention may be practiced. The invention may, however, be embodied in many different forms and should not be regarded as limited to the embodiments set forth herein. Rather, these embodiments are provided so that this disclosure will be thorough and complete and will convey fully the scope of the invention to those skilled in the art. The following detailed description is, therefore, not to be taken in a limiting sense.

The present invention is directed towards enabling a substantially linear delivery of advertisements during the length of an advertisement campaign, where substantially linear means that delivery is acceptably close to a cumulative linear advertisement delivery goal, as described further below. Generally, a tolerance band is determined for the advertisement campaign. The tolerance band defines upper and lower bounds on acceptable deviation from the cumulative linear advertisement delivery goal. For any given point in time during the advertisement campaign, each bound may be expressed as a tolerance percentage (positive for the upper bound and negative for the lower bound). The absolute values of the upper bound and lower bound tolerance percentages (i.e., the width of the band above the line and below the line) are not necessarily equal at any given point in time. Further, each bound may flatten with time: that is, for both the upper bound and the lower bound, the absolute value of the specified acceptable deviation may be higher at the beginning of the advertisement campaign and lower as the advertisement campaign approaches its end date due to the decreased number of impressions available to the advertisement service provider near the end of the advertisement campaign.

A defined tolerance band for an advertisement campaign may be employed to manage delivery of advertisement impressions during the advertisement campaign. Because a tolerance band is specified, rather than a specific target delivery goal, an advertisement server or the like may manage advertisement delivery within the advertisement campaign in a flexible manner. For example, in a system for selecting and distributing advertisements for inclusion in pages requested by network users, a quota server or another facility may periodically calculate a delivery quota for an advertisement line for a period of time within the advertisement campaign. This determined quota may be dynamically modified based on the current performance of the advertisement line in relation to its tolerance band. For example, an advertisement line that has fallen below the lower bound of acceptable deviation from the cumulative linear advertisement delivery goal may have its quota increased relative to other advertisement lines so that it may be given more delivery opportunities. Similarly, an advertisement line that is delivering above its upper bound may have its quota reduced, possibly to zero.

Dynamically modifying the delivery quota based on the current performance of an advertisement in relation to a tolerance band de-couples advertisement delivery from traffic conditions. By de-coupling advertisement delivery from network traffic conditions, advertisement service providers may meet the expectations of advertisers by delivering advertisements at or near a delivery goal independent of the inherent unevenness and unpredictability of network traffic at different hours of the day, different days of the week, or even different times of the year.

To further meet the expectations of advertisers, advertisement service providers may provide a different tolerance band to different advertisers depending on the tier of the advertiser. Advertisers may be grouped in different tiers depending on the volume of advertisements purchased for a given period of time, or any other criteria desired by an advertisement service provider. In order to create good will, an advertisement service provider may wish to give higher tiered advertisers more predictability with respect to their purchased advertisements. For example, an advertisement service provider may desire to provide a more narrow tolerance band to higher tier advertisers than lower tier advertisers. A more narrow tolerance band results in an advertisement delivery that is closer to the expectations of an advertiser of a cumulative linear advertisement delivery goal.

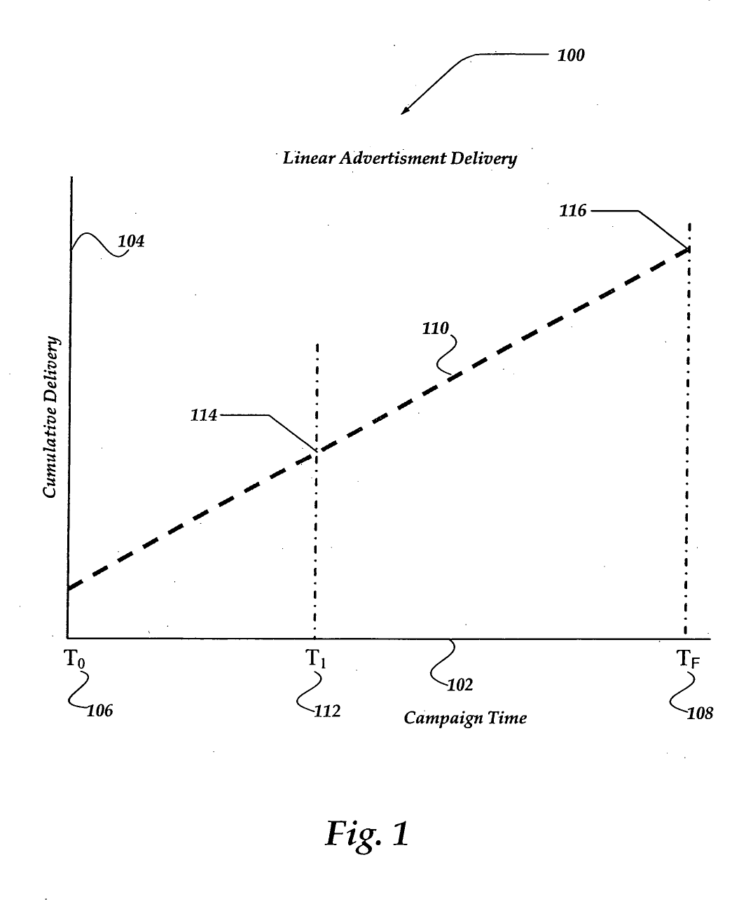

FIG. 1 illustrates a cumulative linear delivery goal for an advertisement campaign over the entire period of an advertisement campaign. FIG. 1 is a graph representing a linear distribution of delivered advertisement impressions during the length of an advertisement campaign. Graph 100 plots cumulative delivery 104 against campaign time 102. Campaign time 102 extends from time TO 106, the campaign start date, to time TF 108, the campaign end date. At any point in campaign time 102, such as time T1 112, the fraction of delivery goal to be met is set equal to the fraction of campaign time elapsed, producing points in the graph such as point 114 at time T1 112. The distribution thus takes the form of a line 110 of positive slope. Actually achieving a completely linear delivery throughout an advertisement campaign may not be realistic, given the difficulty in predicting changes in network traffic, among other reasons. Nevertheless, for a given guaranteed impressions-based campaign, substantially linear cumulative delivery may provide an appropriate basis for a delivery goal for any particular time within the campaign.

Framework for Managing Delivery of Advertisements

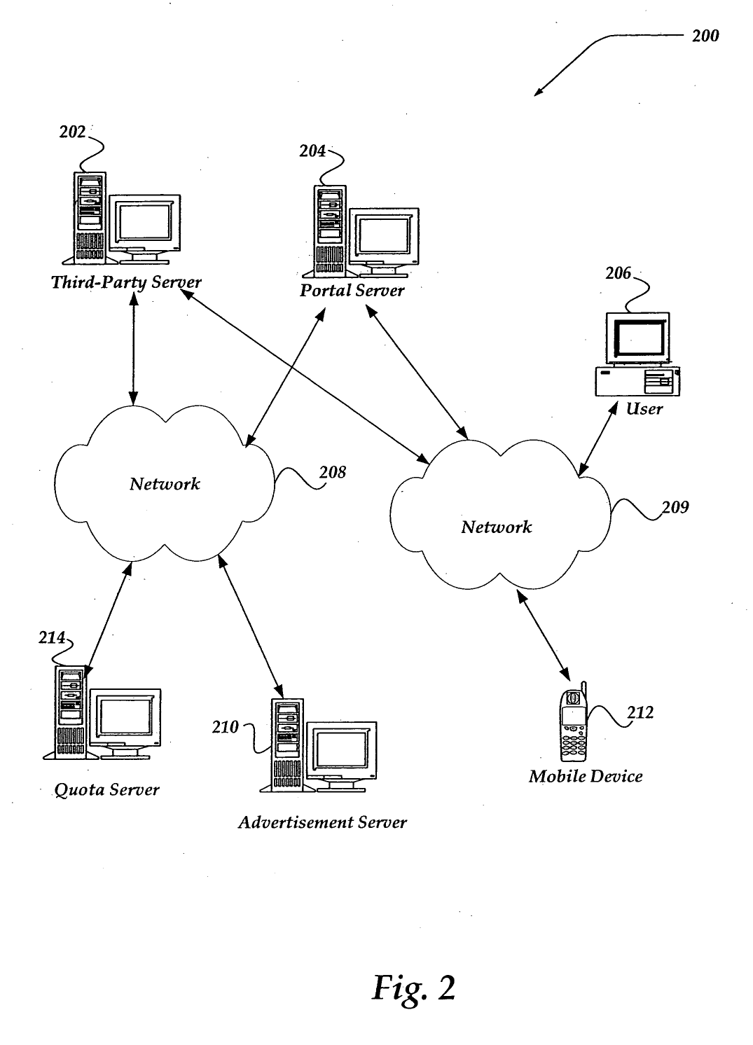

FIG. 2 provides a simplified view of one embodiment of an environment within which the present invention may operate. Not all of the depicted components may be required to practice the invention, however, and some embodiments of the invention may include additional components not shown in the figure. Variations in the arrangement and type of the components may be made without departing from the spirit or scope of the invention.

As illustrated in FIG. 2, environment 200 comprises an advertisement server 210, such as a banner advertisement server, and a quota server 214. Generally, the quota server 214 determines and may dynamically modify a delivery quota for advertisement lines of the advertisement server 210. The quota server 214 provides the delivery quota for the advertisement lines to the advertisement server 210, which selects advertisements and distributes the selected advertisements based on the delivery quota received from the quota server 214. Typically, the advertisement server 210 delivers the selected advertisement to a third party server 202 and/or a portal server 204 for inclusion in pages, such as web pages. The third party server 202 and/or the portal server 204 may then serve the pages to users, represented in FIG. 2 by user 206 (depicted as a conventional personal computer) and web-enabled mobile device 212.

Some or all of the advertisement server 210, portal server 204, third-party server 202, and quota server 214 are in communication by way of network 208. It will be understood that the advertisement server 210, quota server 214, and portal server 204 may each represent multiple linked computing devices, and multiple third-party servers, such as third-party server 202, may be included in environment 200. Network 208 may be regarded as a private network connection and may include, for example, a virtual private network or an encryption or other security mechanism employed over the public Internet, or the like.

User 206 and mobile device 212 represent user-interactive devices that typically run browser applications, and the like, to display requested pages received over a network. Such devices are in communication with portal server 204 and/or third-party server 202 by way of network 209. Network 209 may be the public Internet and may include all or part of network 208; network 208 may include all or part of network 209.

Portal server 204, third-party server 202, quota server 214, advertisement server 210, user device 206, and mobile device 212 each represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, user device 206 may be configured to execute a browser application that employs HTTP to request information, such as a web page, from a web server, which may be a program executing on portal server 204 or third-party server 202.

Networks 208-209 are configured to couple one computing device to another computing device to enable communication of data between the devices. Networks 208-209 may generally be enabled to employ any form of machine-readable media for communicating information from one device to another. Each of networks 208-209 may include one or more of a wireless network, a wired network, a local area network (LAN), a wide-area network (WAN), a direct connection such as through a Universal Serial Bus (USB) port, and the like, and may include the set of interconnected networks that make up the Internet. On an interconnected set of LANs, including networks employing differing protocols, a router acts as a link between LANs, enabling messages to be sent from one to another. Communication links within LANs typically include twisted wire pair or coaxial cable. Communication links between networks may generally use analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other network-enabled electronic devices may be remotely connected to LANs or WANs by way of a modem and temporary telephone link. In essence, networks 208-209 may include any communication method by means of which information may travel between computing devices.

The media used to transmit information across information links as described above illustrate one type of machine-readable media, namely communication media. Generally, machine-readable media include any media that can be accessed by a computing device or other electronic device. Machine-readable readable media may include processor-readable media, data storage media, network communication media, and the like. Communication media typically embody information comprising processor-readable instructions, data structures, program components, or other data in a modulated data signal such as a carrier wave or other transport mechanism. Such media may include any information delivery media. The terms “modulated data signal” and “carrier wave signal” include a signal that has one or more of its characteristics set or changed in such a manner as to encode information, instructions, data, and the like, in the signal. By way of example, communication media include wired media such as twisted pair, coaxial cable, fiber optic cable, and other wired media, and wireless media such as acoustic, RF, infrared, and other wireless media.

Employing a Tolerance Band for Substantially Linear Delivery of Advertisements

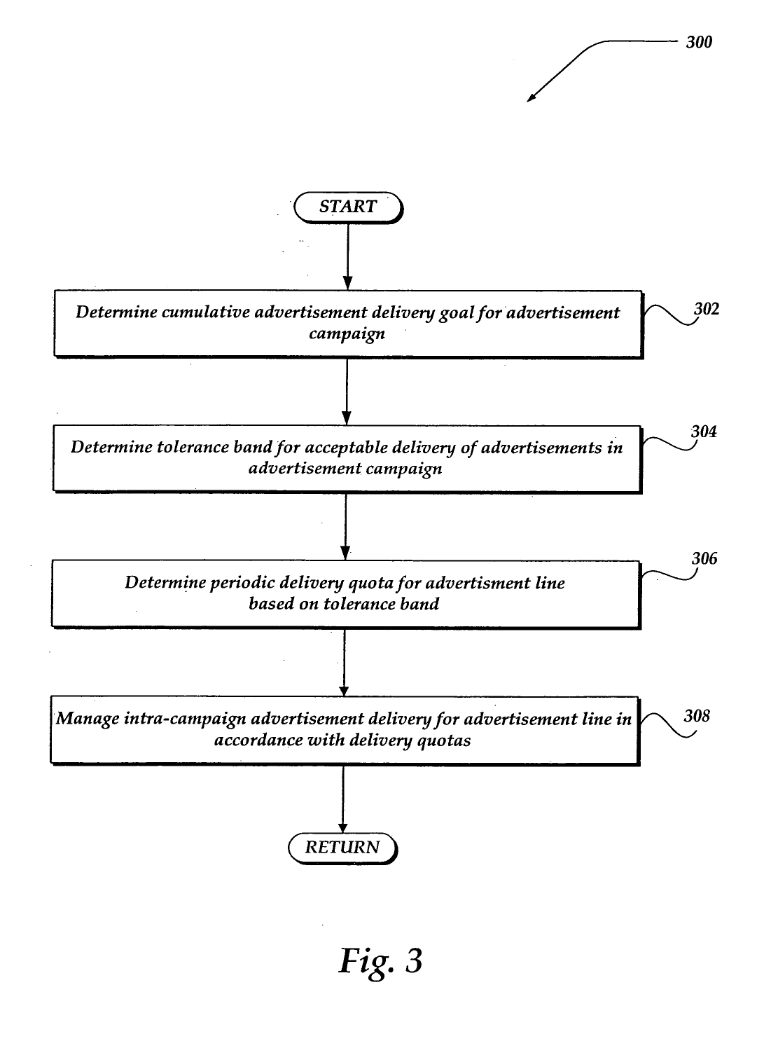

The operation of certain aspects of the invention will now be described with respect to FIGS. 3-10, including the logical flow diagrams of FIGS. 3, 4, 6, 7, and 9, which illustrate aspects of processes for determining a tolerance band for an advertisement campaign and employing the tolerance band to manage selection and delivery of advertisements.

A delivery quota allocated to an advertisement line may be determined based on a tolerance band that is determined for an advertisement campaign. FIG. 3 is a logical flow diagram generally showing one embodiment of a process for managing delivery of advertisements in an advertisement campaign using delivery quotas. Process 300 begins, after a start block, at block 302, where a cumulative linear advertisement delivery goal for an advertisement campaign is determined. Processing then steps to block 304, where a tolerance band for acceptable delivery of advertisements is determined for the advertisement campaign. Next, process 300 flows to block 306, at which a delivery quota for the advertisement line is determined, based in part on the tolerance band. Block 306 may be performed in real-time or periodically at various points in time during the campaign. Processing continues to block 308, where delivery of advertisements for the advertisement line is managed during the campaign in accordance with determined delivery quotas. Process 300 then returns to a calling process to perform other actions.

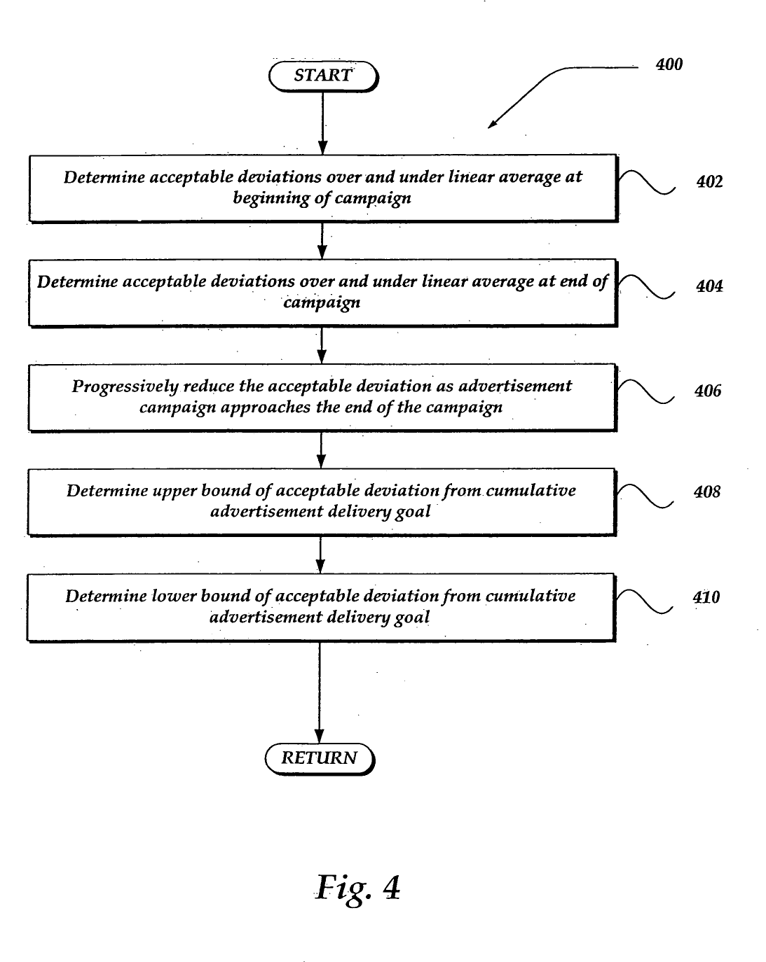

FIG. 4 is a logical flow diagram generally showing one embodiment of a process for determining a tolerance band for an advertisement line. Following a start block, process 400 flows to block 402, at which the acceptable deviations above and below a determined cumulative linear advertisement delivery goal is determined for the beginning of an advertisement campaign associated with the delivery line. Next, at block 404, acceptable deviations above and below the cumulative linear advertisement delivery goal are determined for the end of the advertisement campaign. Process 400 flows to block 406, at which the acceptable deviation from the determined cumulative linear advertisement line is progressively reduced as the advertisement campaign approaches the end date of the campaign. Typically, the progressive reduction is based on a pre-defined formula such as linearly decreasing percentage deviation above and below the cumulative linear advertisement delivery goal.

Process 400 then flows to blocks 408 and 410, where a tolerance band is derived by setting an upper and lower bound of acceptable deviation over the advertisement campaign. Specifically, at block 408, an upper bound is set for acceptable deviation from the cumulative linear advertisement delivery goal for the advertisement line. Similarly, at block 410, a lower bound of acceptable deviation is set for acceptable deviation from the cumulative linear delivery goal for the advertisement line. Processing then returns to a calling process to perform other actions.

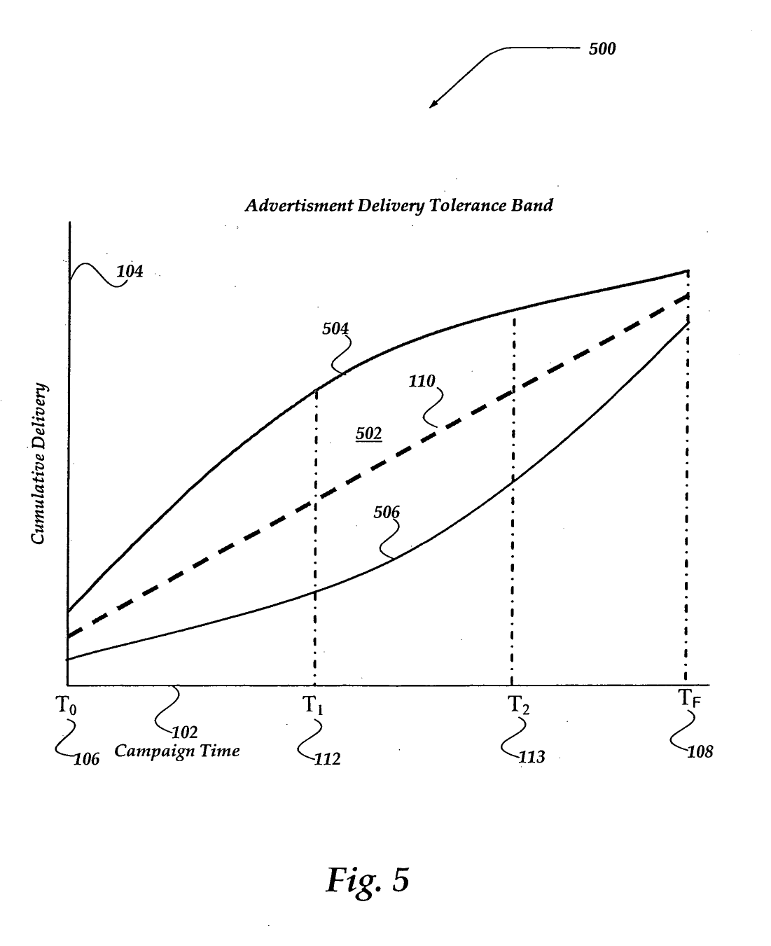

FIG. 5 illustrates a graph of a tolerance band for delivery of an advertisement line in an advertisement campaign. As in FIG. 1, graph 500 plots cumulative delivery 104 against campaign time 102. Tolerance band 502 encompasses relatively linear delivery goal 110 and is defined by upper bound 504 and lower bound 506, which are curves whose points are percentages above and below cumulative linear advertisement delivery goal 110 at particular times during the course of the campaign. As graph 500 shows, typically the tolerance percentage above and below cumulative linear advertisement delivery goal 110 is relatively high in the earlier part of an advertisement campaign, such as at time T1 112. However, towards the end of the campaign, such as at times T2 113 or campaign end date TF 108, the tolerance percentage is typically relatively low.

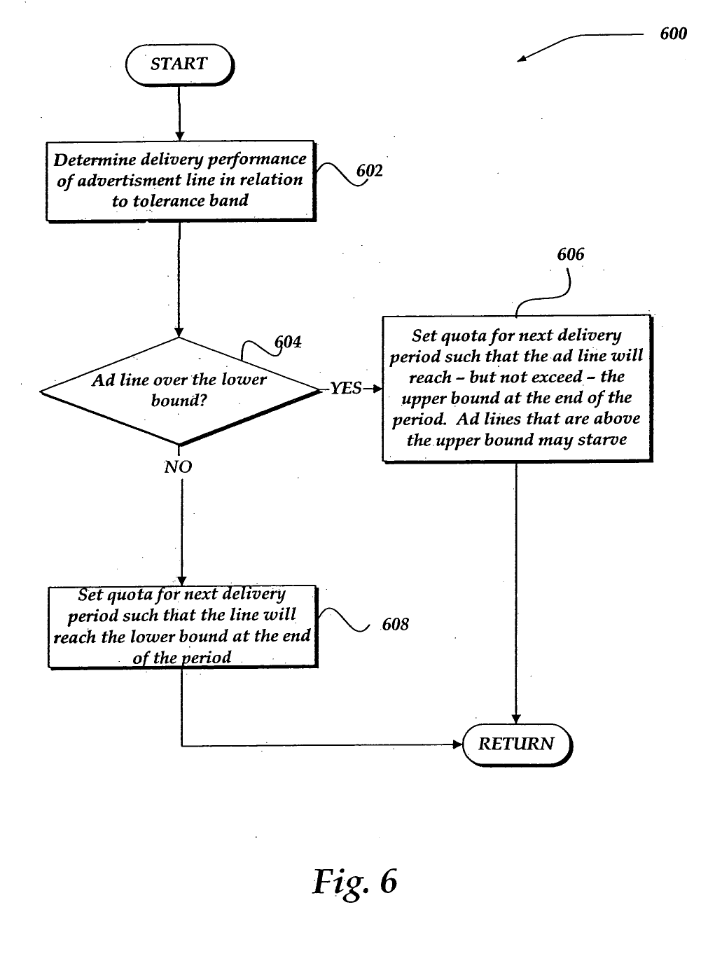

FIG. 6 is a logical flow diagram generally showing one embodiment of a process for employing a tolerance band to derive delivery quotas of an advertisement campaign for the next delivery interval. Process 600 begins, after a start block, at block 602, where the delivery performance of an advertisement line is determined in relation to a tolerance band. Processing then flows to block 604, where it is determined whether an advertisement line is over the lower bound of its tolerance band.

If the advertisement line is delivering over the lower bound of its tolerance band, process 600 flows to block 606. At block 606, the delivery quota for the advertisement line is set for the next delivery period such that the advertisement line reaches, but does not exceed, the upper bound of the tolerance band at the end of the delivery period. Accordingly, any other advertisement line that is above its upper bound of the tolerance band may be set to starve during the next delivery period. Processing then returns to a calling process to perform other actions.

If the advertisement line is not delivering over its lower bound, process 600 flows to block 608. At block 608, the delivery quota for the advertisement line is set for the next delivery period such that the advertisement line will reach the lower bound of the tolerance band at the end of the delivery period. Processing then returns to a calling process to perform other actions.

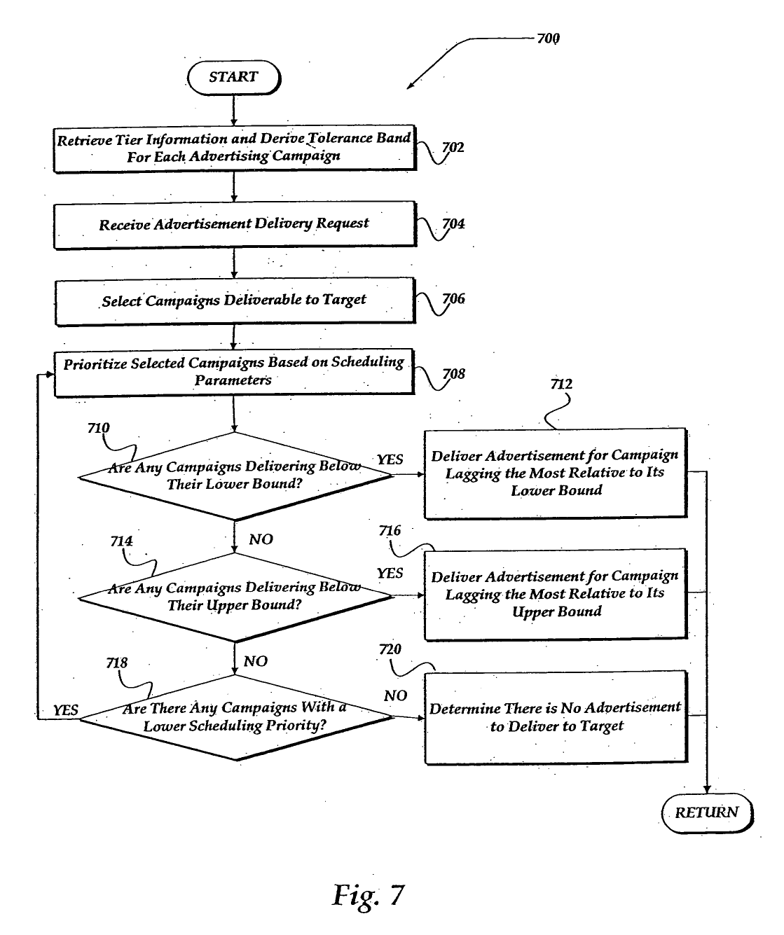

FIG. 7 is a logical flow diagram of one embodiment for an advertisement service provider employing tolerance bands to prioritize delivery of more than one advertisement lines. Following the start block, process 700 flows to block 702. At block 702, the advertisement service provider retrieves the tier information for each advertiser associated with an advertisement campaign and derives the permissible deviation from the cumulative linear advertisement delivery goal (the tolerance band) for each advertisement campaign as a function of the retrieved tier information as described in section 0034-0035 and depicted in FIG. 4.

After block 702, the process 700 flows to block 704, where the advertisement service provider receives a request for delivery of an advertisement line from a target. The advertisement service provider selects the advertisement campaigns that are deliverable to the target requesting delivery of the advertisement line 706 and prioritizes the advertisement campaigns based on scheduling parameters 708.

The advertisement service provider then determines if any of the advertisement campaigns are currently delivering advertisement lines below the advertisement campaign's lower bound 710. If any of the campaigns are delivering advertisement lines below their lower bound, an advertisement is delivered to the target for the advertisement campaign that is lagging the most relative to its lower bound 712. If none of the campaigns are delivering below their lower bound, the process 700 proceeds to decision block 714.

At decision block 714, the advertisement service provider determines whether any of the advertisement campaigns are delivering below their upper bound. If any of the advertisement campaigns are delivering below their upper bound, an advertisement line is delivered to the target for the advertisement campaign that is lagging the most relative to its upper bound 716. If none of the advertisement campaigns are delivering below their upper bound, the process 700 proceeds to decision block 718.

At decision block 718, the advertisement service provider determines whether there are any advertisement campaigns with a lower scheduling priority. If there are no advertisement campaigns with lower scheduling priority, the advertisement service provider determines there are no advertisements to deliver to the target that requested delivery of an advertisement 720. However, if there are advertisement campaigns with lower scheduling priority, the process 700 returns to block 708 and repeats the above-described process.

Constrained Bands for Intra-Campaign Subperiods

In one embodiment, one or more predetermined subperiods within the advertisement campaign may be associated with a short-term flattening of the operative tolerance range. Such subperiods may include periods during which campaign status reporting and/or billing takes place. During such subperiods, greater predictability of advertisement delivery information may be desirable so that reporting discrepancies may be avoided. For such a subperiod, flattening may be employed by specifying a smaller tolerance range for the lower and upper bounds, temporarily moving the advertisement campaign closer to a cumulative linear advertisement delivery goal. Following the end of the subperiod, the original curves may be restored. At any point within the subperiod, the tighter of the campaign bound and the subperiod bound is employed to determine the effective tolerance bound for advertisement delivery.

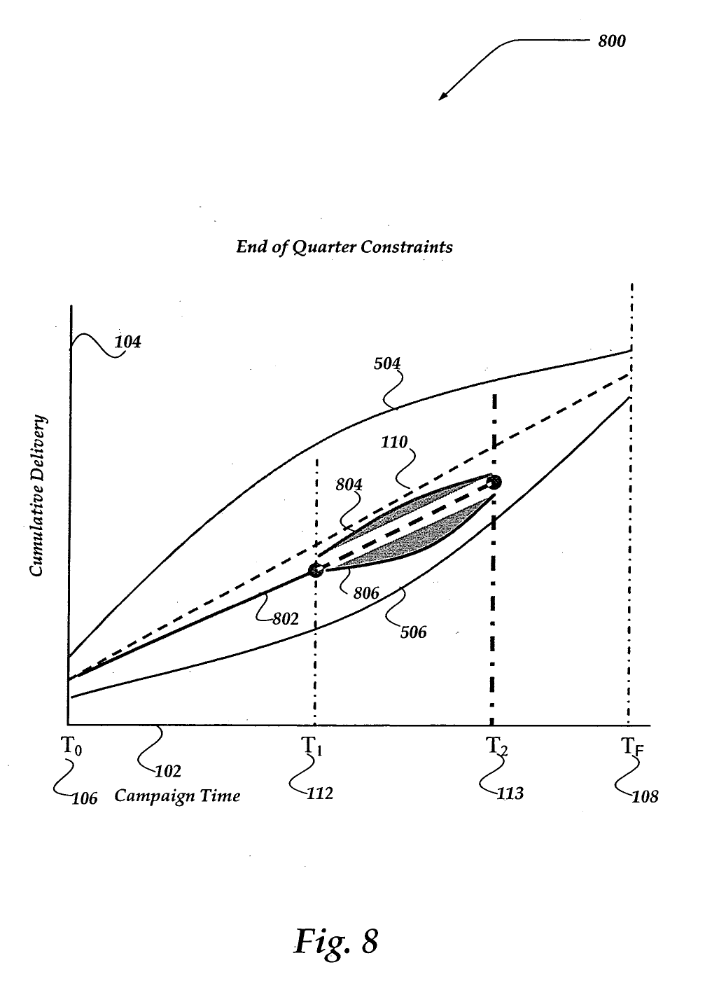

FIG. 8 illustrates a graph of a tolerance band in which a narrower tolerance band is employed for a subperiod corresponding to the close of a sales quarter. The subperiod in graph 800 begins at time T1 112, which may be, for example, the twelfth day of the last month of the quarter. The subperiod ends at time T2 113, corresponding to the quarter close. Actual delivery of advertisements in graph 800 is represented by line 802. As illustrated in graph 800, during the subperiod advertisement delivery is constrained by imposing a tighter upper bound 804 and lower bound 806 in relation to line 802 of actual delivery. In one embodiment, only one tighter bound, such as a tighter lower bound, is employed during such a subperiod.

Delivery for Lines Booked “Out-of-Band”

Certain kinds of advertisement lines may not be deliverable in a substantially linear manner or within a general tolerance band. In particular, for some advertisement lines, sufficient advertisement inventory may be available over the period of the advertisement campaign, but the inventory might not be distributed in a manner that would make delivery within a campaign-length tolerance band possible or practicable. For example, 200,000 impressions may be available during a first month and 800,000 impressions may be available during the following month. An advertisement line might be booked with a one million impressions goal to be delivered in a campaign extending over the two months. Successful delivery within a single tolerance band would be unlikely. Such lines may be referred to as an advertisement line booked “out-of-band.”

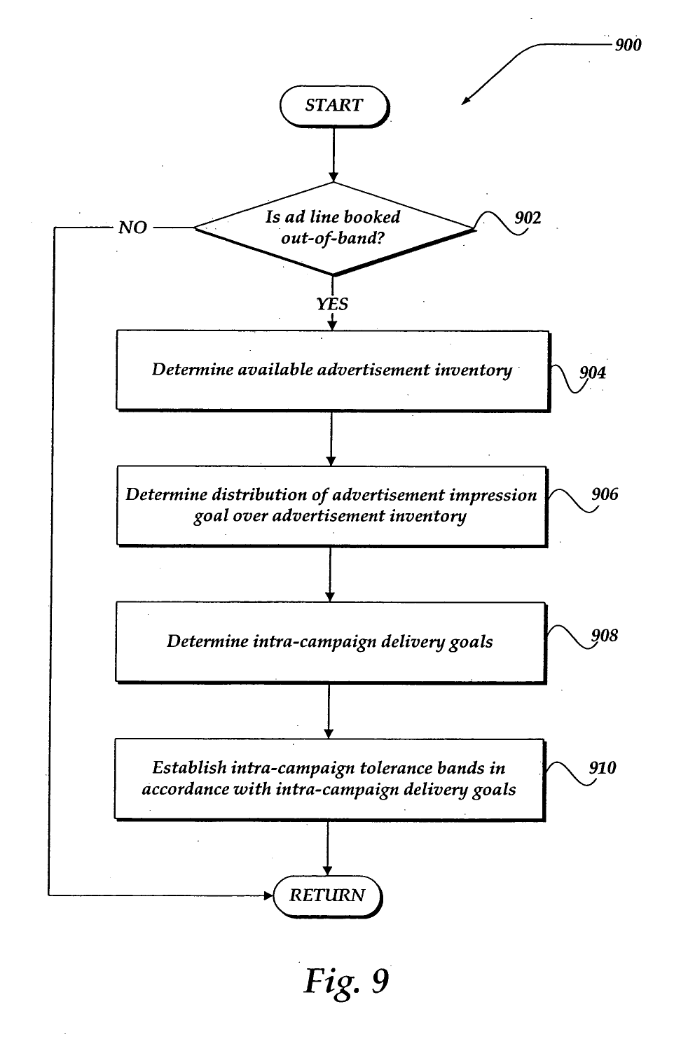

FIG. 9 is a logical flow diagram generally showing one embodiment of a process for establishing multiple intra-campaign tolerance bands for an advertisement line that is booked out-of-band. Following a start block, process 900 flows to decision block 902, at which it is determined whether the advertisement line is one that is booked out-of-band. If the determination is negative, processing returns to a calling process to perform other actions. If, however, the decision at block 902 is affirmative, process 900 flows to block 904, where available inventory for the advertisement line is determined. Processing flows next to block 906, where a distribution of the impression goal over the available inventory is determined. Process 900 then flows to block 908, where, based on the previously-determined information, one or more intra-campaign delivery milestones or goals are determined. Next, at block 910, separate intra-campaign tolerance bands are established in accordance with the determined intra-campaign delivery goal or goals. Processing then returns to a calling process to perform other actions.

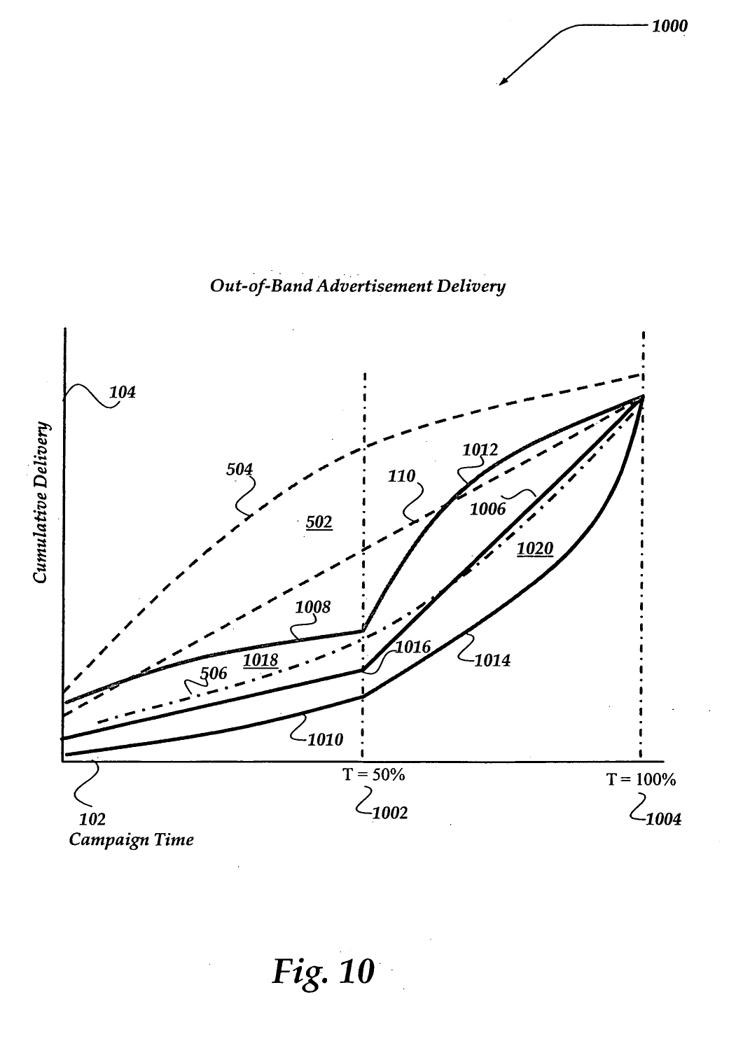

FIG. 10 illustrates a graph of delivery for an out-of-band advertisement line in which multiple intra-campaign tolerance bands are employed. Graph 1000 is based on the example given above of a two-month campaign with a goal of one million impressions, in which 200,000 impressions are available during the first month and 800,000 impressions are available during the second month. Instead of using cumulative linear advertisement delivery goal 110 to determine upper bound 504 and lower bound 506 of campaign-length tolerance band 502, expected delivery 1006 is determined based on inventory. Expected delivery 1006 here includes two lines divided by intra-campaign milestone 1016 at time T=50% 1002, the end of the first month, at which it may be predicted that 20 percent of the impressions will be delivered. Delivery of 50 percent of impressions may be expected by approximately the sixth week of the campaign.

Based on expected delivery 1006 and intra-campaign milestone 1016, two tolerance bands 1018 and 1020 are determined for the first and second months of the campaign, respectively. First tolerance band 1018 is defined by upper bound 1008 and lower bound 1010. Second tolerance band 1020 is defined by upper bound 1012 and lower bound 1014.

The embodiments described here overcome the difficulties experienced by advertisement service providers (“publishers”) in managing advertisement delivery in a campaign without under-delivery and over-delivery of advertisement lines. Employing the above-described system allows advertisement service providers to de-couple delivery of advertisement lines from traffic conditions and better meet the expectations of advertisers by providing substantially linear delivery of advertisement lines over the length of an advertisement campaign.

It is therefore intended that the foregoing detailed description be regarded as illustrative rather than limiting, and that it be understood that it is the following claims, including all equivalents, that are intended to define the spirit and scope of this invention.

1. A method for providing advertising content over a network, comprising:
determining a cumulative delivery goal for a period of an advertisement campaign, wherein a fraction of advertisements that are delivered is associated with a fraction of campaign time that elapses;
determining a tolerance band for deviation from the cumulative delivery goal; and
employing the tolerance band to select an advertisement to be provided over the network.

2. The method of claim 1, wherein the cumulative delivery goal is a cumulative linear delivery goal.

3. The method of claim 1, wherein the advertising content includes at least one of a banner advertisement or a guaranteed impression advertisement.

4. The method of claim 1, wherein employing the tolerance band to select the advertisement further comprises:
determining a delivery quota for an advertisement line associated with the advertisement campaign.

5. The method of claim 1, wherein determining the tolerance band further comprises:
determining an upper bound that establishes acceptable delivery in excess of the cumulative delivery goal for the advertisement campaign; and
determining a lower bound that establishes acceptable delivery below the cumulative delivery goal for the advertisement campaign.

6. The method of claim 5, further comprising:
modifying the upper and/or lower bounds for a subperiod of the advertisement campaign period to reduce acceptable deviation.

7. The method of claim 5, further comprising:
determining a tier of an advertiser associated with the advertisement campaign;
wherein the upper and lower bounds are determined as a function of the tier of the advertiser associated with the advertisement campaign.

8. The method of claim 5, further comprising:
flattening at least one of a curve associated with the upper bound and a curve associated with the lower bound.

9. The method of claim 1, further comprising:
determining an intermediate delivery milestone for the advertisement campaign period;
determining a first tolerance band for a first subperiod that ends at the intermediate delivery milestone; and
determining a second tolerance band for a second subperiod that begins at the intermediate delivery milestone.

10. A server for providing advertising content over a network, comprising:
a memory for use in storing data and instructions;
a processor in communication with the memory, the processor operative to enable actions based on the stored instructions to perform acts of:
determining a cumulative delivery goal for a period of an advertisement campaign, wherein a fraction of advertisements that are delivered is associated with a fraction of campaign time that elapses;
determining a tolerance band for deviation from the cumulative delivery goal; and
enabling the tolerance band to be employed in selecting an advertisement to be displayed in a page.

11. The server of claim 10, wherein the cumulative delivery goal is a cumulative linear delivery goal.

12. The server of claim 10, wherein the advertising content includes at least one of a banner advertisement or a guaranteed impression advertisement.

13. The server of claim 10, wherein determining the tolerance band further comprises:
determining an upper bound that establishes acceptable delivery in excess of the cumulative delivery goal for the advertisement campaign; and
determining a lower bound that establishes acceptable delivery below the cumulative delivery goal for the advertisement campaign.

14. The server of claim 13, wherein determining the tolerance band further comprises:
determining a tier of an advertiser associated with the advertisement campaign;
wherein the upper and lower bounds are determined as a function of the tier of the advertiser associated with the advertisement campaign.

15. The server of claim 13, wherein the processor is further operative to perform acts of:
flattening at least one of a curve associated with the upper bound and a curve associated with the lower bound.

16. The server of claim 10, wherein the processor is further operative to perform acts of:
modifying the tolerance band for a subperiod of the advertisement campaign period to reduce acceptable deviation.

17. The server of claim 10, wherein the processor is further operative to perform acts of:
determining an intermediate delivery milestone for the advertisement campaign period;
determining a first tolerance band for a first subperiod that ends at the intermediate delivery milestone; and
determining a second tolerance band for a second subperiod that begins at the intermediate delivery milestone.

18. A computer-readable storage medium containing a set of instructions for providing advertising content over a network, the set of instructions to direct a computer system to perform acts of:
determining a relatively linear cumulative delivery goal for a period of an advertisement campaign, wherein a fraction of advertisements that are delivered is associated with a fraction of campaign time that elapses;
determining a tolerance band for deviation from the linear cumulative delivery goal; and
employing the tolerance band to select an advertisement to be displayed in the page.

19. A method for providing advertising line data over a network, comprising:
determining tier information for an advertiser associated with each of a plurality of advertisement campaign data files;
deriving an upper bound and a lower bound of permissible deviation from a cumulative delivery goal for each of the plurality of advertisement campaign data files based on the tier information for the advertiser associated with the advertisement campaign data file;
receiving from a target a request for delivery of advertisement line data;
selecting a subgroup of advertisement campaign data files from the plurality of advertisement campaign data files that are deliverable to the target;
determining whether any advertisement campaign data files of the subgroup are delivering advertisement line data below the lower bound of permissible deviation of the advertisement campaign data file; and
delivering advertisement line data from one of the advertisement campaigns of the subgroup delivering advertisement line data below the lower bound of permissible deviation in response to determining at least one advertisement campaign data file of the subgroup is delivering advertisement lines below the lower bound of permissible deviation.

20. The method of claim 19, wherein the cumulative delivery goal is a cumulative linear delivery goal.

21. The method of claim 19, wherein delivering advertisement line data from one of the advertisement campaign data files of the subgroup delivering advertisement line data below the lower bound of permissible deviation comprises:
delivering advertisement line data from the advertisement campaign data file that is delivering advertisement line data below the lower bound of permissible deviation the most relative to the lower bound of the advertisement campaign data file.

22. The method of claim 19, further comprising:
determining whether any of the advertisement campaign data files of the subgroup are delivering advertisement lines below the upper bound of permissible of permissible deviation of the advertisement campaign data file; and
delivering advertisement line data from one of the advertisement campaigns of the subgroup delivering advertisement lines below the upper bound of permissible deviation in response to determining at least one advertisement campaign data file of the subgroup is delivering advertisement line data below the upper bound of permissible deviation.

23. The method of claim 22, wherein delivering advertisement line data from one of the advertisement campaign data files of the subgroup delivering advertisement line data below the upper bound of permissible deviation comprises:
delivering advertisement line data from the advertisement campaign data file of the subgroup that is delivering advertisement line data below the upper-bound of permissible deviation the most relative to the upper bound of the advertisement campaign data file.

24. The method of claim 22, further comprising:
prioritizing the advertisement campaign data files within the subgroup based on scheduling parameters;
determining whether any of the advertisement campaign data files of the plurality of advertisement campaigns have a lower scheduling priority than the advertisement campaign data files of the subgroup; and
determining there is no advertisement line data to deliver to the target in response to determining none of the advertisement campaign data files of the plurality of advertisement campaign data files have a lower scheduling priority than the advertisement campaign data files of the subgroup.

25. A server for providing advertising content over a network, comprising:
a memory means for use in storing data and instructions; and
a processor means in communication with the memory means, the processor means operative to enable actions based on the stored instructions;
wherein the instructions stored in the memory means comprise:
programming code for the processor to determine a cumulative delivery goal for a period of an advertisement campaign data file, wherein a fraction of advertisement data that is delivered is associated with a fraction of campaign time that elapses;
programming code for the processor to determine a tolerance band for deviation from the cumulative delivery goal; and
programming code for the processor to employ the tolerance band in selecting advertisement data to be displayed in a page.

26. The server of claim 25, wherein the cumulative delivery goal is a cumulative linear delivery goal.

27. The server of claim 25, wherein the advertising data includes at least one of a banner advertisement or a guaranteed impression advertisement.

28. The server of claim 25, wherein the programming code for the processor to determine the tolerance band further comprises:
programming code for the processor to determine an upper bound that establishes acceptable delivery in excess of the cumulative delivery goal for the advertisement campaign data file; and
programming code for the processor to determine a lower bound that establishes acceptable delivery below the cumulative delivery goal for the advertisement campaign data file.

29. The server of claim 28, wherein the programming code for the processor to determine the tolerance band further comprises:
programming code for the processor to determine a tier of an advertiser associated with the advertisement campaign data file;
wherein the upper and lower bounds are determined as a function of the tier of the advertiser associated with the advertisement campaign data file.

30. The server of claim 28, wherein the memory means further stores:
programming code for the processor to flatten at least one of a curve associated with the upper bound and a curve associated with the lower bound.

31. The server of claim 25, wherein the memory means further stores:
programming code for the processor to modify the tolerance band for a subperiod of the advertisement campaign period to reduce acceptable deviation.

32. The server of claim 25, wherein the memory means further stores:
programming code for the processor to determine an intermediate delivery milestone for the advertisement campaign period;
programming code for the processor to determine a first tolerance band for a first subperiod that ends at the intermediate delivery milestone; and
programming code for the processor to determine a second tolerance band for a second subperiod that begins at the intermediate delivery milestone.
